(19) United States
(12) Patent Application Publication
(10) Pub. No.: US 2003/0116006 A1
(43) Pub. Date: Jun. 26, 2003

(54) Sawtooth wire

(76) Inventor: Ralph A. Graf, Freienbach (CH)

Correspondence Address: Friedrich Kueffner, Suite 910, 317 Madison Avenue, New York, NY, 10017, US

(21) Appl. No.: 10/366,210

(22) Filed: Feb. 13, 2003

Related U.S. Application Data
(62) Division of application No. 09/710,111, filed on Nov. 9, 2000.

(30) Foreign Application Priority Data
Nov. 10, 1999 (EP) 99 122 418.9

(51) Int. Cl. B27B 13/02; B27B 33/14

(52) U.S. Cl. 83/835

(57) ABSTRACT

The invention relates to a sawtooth wire for manufacturing an all-steel sawtooth wire arrangement for the swift of a card. The sawtooth wire has a foot section and a blade section adjoining the foot section at a foot shoulder, wherein the blade section has sawteeth formed by tooth cutouts extending from the edge of the blade section facing away from the foot section. The ratio of the foot width to the blade width at the location of the deepest tooth cutout is greater than 2 and preferably greater than 2.5.

This application is a divisional of application Ser. No. 09/710,111 filed Nov. 9, 2000, and still pending.

### BACKGROUND OF THE INVENTION

1. Field of the Invention

The invention relates to a sawtooth wire for producing an all-steel sawtooth arrangement for the swift of a card, comprising a foot section and a blade section adjoining the foot section via a foot shoulder, wherein the blade section comprises sawteeth which are formed by tooth cutouts extending from the edge of the blade section facing away from the foot section.

2. Description of the Related Art

During fiber processing, the card is used for parallel alignment of the individual fibers of a raw material with randomly arranged fibers. For this purpose, the card has conventionally a circular cylindrical swift and several card flat bars extending about the circumferential surface of the swift. For the purpose of parallel alignment, the swift as well as the card flat bars are conventionally provided with all-steel arrangements formed of sawtooth wires between which the parallel alignment takes place. In this connection, the all-steel sawtooth arrangement of the swift is conventionally in the form of a sawtooth wire which is guided circumferentially in a coil shape about the circular cylindrical mantle surface of the swift while the all-steel sawtooth arrangement of the card flat is formed by adjacently arranged sawtooth wire sections. With such cards more than 120 kg of raw material per hour can be processed or aligned in parallel. In this connection, a satisfactory card output can be ensured when for the swift of the card all-steel sawtooth wire arrangements according to EP 0 360 961 B2 are used. However, it was found that these known all-steel sawtooth wire arrangements during operation, especially in connection with the aforementioned high production outputs, are subject to great wear.

In CH 660 884 A5 the problem of great wear of card arrangements has already been discussed. As a solution to this problem it is suggested in the aforementioned document to employ special steel alloys for producing these card arrangements. However, this already entails the further problem that especially wear-resistant steel alloys are also particularly expensive so that in the context of card arrangements the cost-performance optimum is not correlated with the maximum wear resistance but with the selection of a material for the arrangement for which the increase of the wear resistance is not cancelled out by the increased material and manufacturing costs. Accordingly, when using the alloy steels disclosed in the aforementioned Swiss patent document for producing the card arrangements of the kind described in EP 0 360 961 B2, the aforementioned problems with respect to wear resistance must still be considered.

### SUMMARY OF THE INVENTION

It is an object of the present invention to provide a sawtooth wire for producing an all-steel sawtooth wire arrangement for the swift of a card which, while avoiding excessive material cost and ensuring a satisfactory card output, exhibits a high wear resistance during the carding operation.

According to the invention, this is achieved in that the ratio of the foot width to the blade width at the location of the deepest tooth cutout is greater than 2, preferably greater than 2.5, especially preferred approximately 2.6.

The invention is based on the recognition that the wear observed during the operation of the known cards of the swift arrangement is primarily a result of the forces exerted onto the blade flanks by the fibers which are caught between the blade sections of the individual windings of the arrangement. According to the inventive further development of the sawtooth wires, the width of the arrangement grooves between the individual windings of the swift arrangement in comparison to the blade width is increased in order to thus facilitate the loosening of the fibers which have been caught in these arrangement grooves and to thus reduce the loading of the blade flanks caused by these fibers. In other words, with the inventive further development of the known sawtooth wires, the free space between the foot shoulder and the tooth tip is enlarged so that the fiber material has more space and can be removed from this free space more easily. This is especially important with respect to obtaining a high wear resistance for high production outputs and/or when processing long staple cotton fibers. It was found that with this further development throughput amounts of 1000 tons and more could be obtained with only one swift arrangement, without resulting in wear worth mentioning.

In this connection, when using the sawtooth wires according to the invention for producing an all-steel sawtooth arrangement for the swift of a card, it was surprisingly found that the resulting widening of the arrangement grooves relative to the width of the blade section had no effect worth mentioning on the carding output, i.e., the degree of parallel alignment obtained by the carding process. However, it was found that especially good carding results can be obtained when the ratio of the foot width to the blade width at the location of the deepest tooth cutout is less than 3.5, preferably less than 3. When employing the arrangements according to the invention, the desired large free space between the foot shoulder and the tooth tip can be realized, while avoiding too small a stability of the blade section and simultaneously ensuring an especially good carding result, when the blade width, starting at the edge of the blade section facing away from the foot section, increases in the direction toward the foot section at least over portions thereof continuously and the ratio of the foot width to the blade width at the foot is greater than 1.4, preferably approximately 1.6. In this connection, it was found to be especially expedient when the foot width is approximately 0.2 to 0.6 mm, preferably approximately 0.4 mm, while the blade width at the edge of the blade section, facing away from the foot section, is approximately 0.02 to 0.2 mm, preferably approximately 0.5 mm, and the blade width at the foot is approximately 0.2 to 0.3 mm, preferably approximately 0.24 mm.

A further enlargement of the free space between the foot shoulder and the tooth tip for increasing the wear resistance of the sawtooth wire according to the invention is made possible, while simultaneously ensuring that a satisfactory carding result is achieved, by using corresponding sawteeth when the ratio of the blade height to the depth of the tooth cutout is more than 1.5, preferably more than 1.8, especially preferred approximately 2, wherein the tooth cutout depth required for manufacturing sawteeth providing a satisfactory carding result can be approximately 0.4 mm.

However, in this connection it must be taken into consideration that the enlarged free space between the foot shoulder and the tooth tip of the sawtooth wires according to the invention also results in an increase of the air volume which is entrained during the carding process by the rotation of the swift, which also can have an effect on the carding result. For avoiding an excessive free space between the foot shoulder and the tooth tip, the ratio of the blade height to the tooth cutout depth is expediently limited to at most 3.5, preferably at most 2.5.

With respect to preventing excessive material costs while ensuring at the same time a sawtooth wire having sufficient stability for being applied to the swift of the card, it was found to be advantageous when the ratio of the blade height to the total height of the wire is greater than 0.3, preferably greater than 0.4, and particularly preferred approximately 0.45, but smaller than 0.6, preferably smaller than 0.5. In this connection, it was found to be furthermore beneficial when the total height of the wire is less than 2.0 mm, preferably approximately 1.8 mm wherein the foot height is less than 1.4 mm, preferably approximately 1.0 mm. By a proper selection of the ratio of the blade height to the total height of the wire, it is possible, in particular, to ensure also a good wear resistance because by means of the adjustment of a sufficiently great blade height relative to the total height an especially large free space, which increases the wear resistance, can be insured between the tooth tips and the foot shoulder.

As has been explained in the beginning, for achieving a wear resistance as high as possible, it was found to be advantageous when the sawtooth wire according to the invention is comprised of alloyed steel. This alloyed steel can comprise 0.3 to 2.0, preferably 0.8 to 0.85, % by weight carbon, 0.1 to 0.25, preferably 0.15 to 0.35, % by weight silicon, 0.1 to 2.0, preferably 0.4 to 0.6, % manganese, 0.1 to 2.0, preferably 0.15 to 0.2, % vanadium, and/or 0.1 to 2.0, preferably 0.4 to 0.6, % by weight chromium, wherein the proportions of phosphorus, sulfur, nickel, and copper are kept at a minimal level. In this connection, the phosphorus proportion is expediently limited to less than 0.025% by weight and the sulfur proportion is limited to less than 0.25% by weight.

With respect to obtaining a high wear resistance, it was found to be expedient when the roughness at the lateral flanks of the blade sections, at least in the area of the teeth, is less than 5 μm, preferably less than 4 μm, because an excessive roughness results in increased friction and thus also in increased wear. This minimal roughness can be achieved when the sawtooth wires, after a stamping and hardening process, are subjected to a separate processing step for obtaining the desired surface properties. In this connection, it was found to be especially expedient when the sawtooth wires in this separate processing step are subjected in a deburring and polishing device to an electroplating polishing process.

Moreover, the service life of an arrangement produced with a sawtooth wires according to the invention can be increased when the pitch error, i.e., the deviation from the nominal spacing between tooth tips of successively arranged teeth is less than 2%, preferably less than 1%, because with a correct assembly of the arrangement it is no longer required to perform a control grinding step, which results in first wear, or a first equalizing step. The minimization of the pitch errors can also be achieved in that during the wire manufacture, especially during the stamping process, a high precision wire advancing device is used which is controlled by a regulating compensation computer. With a corresponding sensing method, for example, a laser sensing method, possibly occurring pitch errors during the manufacture can be immediately measured and corrected.

Moreover, for maintaining a high wear resistance it was found to be especially expedient when the individual teeth of the sawtooth wire according to the invention are formed as arc teeth with an arc-shaped tooth breast wherein the radius of curvature of the tooth breast is expediently approximately 0.15 to 0.25 mm, especially preferred approximately 0.19 mm. In this connection, a gentle engagement of the fiber material to be parallel aligned is ensured when the tooth breast in the direction toward the tooth tip has a straight section whose length is preferably in the range of 0.02 to 0.2 mm.

In the following, the invention will be explained with the aid of the drawing to which reference is expressly being had with respect to all details that are important to the invention but not explained in detail in the description.

### BRIEF DESCRIPTION OF THE DRAWING

In the drawing:

FIG. 1 is a side view of the sawtooth wire according to the invention;

FIG. 2 is a sectional view of the sawtooth wire illustrated in FIG. 1; and

FIG. 3 is a detail illustration of a sawtooth of the sawtooth wire illustrated in FIG. 1.

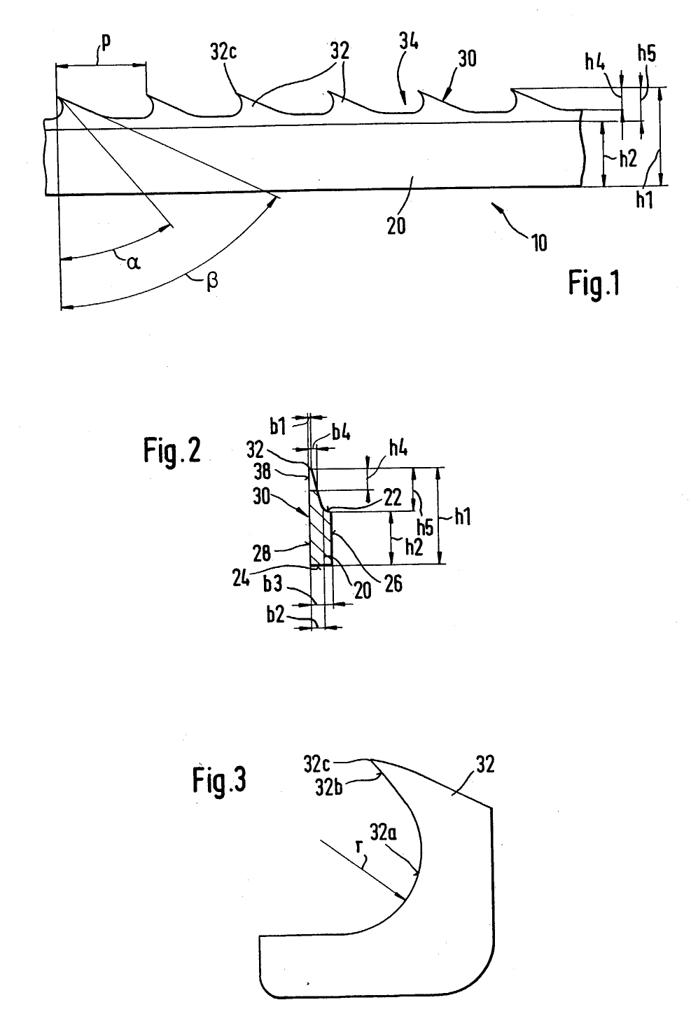

### DESCRIPTION OF THE PREFERRED EMBODIMENTS

The sawtooth wire 10 illustrated in the drawing is comprised substantially of a foot section 20 and a blade section 30. The foot section 20, at its side facing away from the blade section 30, is delimited by a substantially planar lower bottom surface 24 from which two flank surfaces 26 and 28, extending at a right angle thereto, project and extend in the direction toward the blade section 30. With this shape of the foot section it is achieved that the sawtooth wire illustrated in the drawing can be mounted on a swift with a smooth roll surface wherein then the sawtooth wire extending in a coil shape about the circumference is arranged such that the flank surfaces of the foot sections of adjacently positioned windings rests against one another.

The foot section has a transition, starting at the flank surface 26, via a foot shoulder 29 into the blade section 30 which is provided with a number of teeth 32. The teeth 32 are formed by tooth cutouts 34 which extend, starting at the edge of the blade section 30 facing away from foot section 20, in the direction toward the foot section 20. In the embodiment illustrated in the drawing, the tooth pitch p, i.e., the spacing between the tooth tips of successively arranged teeth, is constant and is approximately 1.669 mm. As can be seen especially clearly in FIG. 2, the flank surface 38 of the blade section 30 is coplanar to the flank surface 28 of the foot section 20 wherein the width of the blade section, starting at the tooth tips 32, increases continuously in the direction toward the foot section 20. In this connection, the width b1 of the blade section in the area of the tooth tips is approximately 0.05 mm, while the width b2 of the blade section 30 on the foot 20 is approximately 0.24 mm, wherein the width b4 at the intermediately positioned location of the deepest tooth cutout is approximately 0.15 mm. The width b3 of the foot section is approximately constant over its entire height and is 0.4 mm in the embodiment of the invention illustrated in the drawing.

In the embodiment of the invention illustrated in the drawing, the total height of the sawtooth wire h1 is 1.8 mm, the height h2 of the foot section is 1.0 mm, the tooth cutout depth h4 is 0.4 mm, and the height h5 of the blade section is 0.8 mm.

As is illustrated particularly clearly in FIG. 3, the individual teeth 32 are in the form of arc teeth with a forwardly curved curvature in the direction toward the tooth tip 32c. In this connection, the radius of curvature r is 0.19 mm. In the direction toward the tooth tip 32c the curved portion 32a of the tooth breast of the teeth 32 extends into a straight section 32b. The straight section ensures a gentle engagement of the teeth in the fiber material. The teeth 32 of the sawtooth wire illustrated in the drawing have a breast angle α of 40° in the area of their tips 32c when in the stretched state. The angle β between the approximately straight tooth back and a straight line extending perpendicularly to the lower bottom surface 24 of the wire 10 is 65° so that a wedge angle of 25° results. With the explained adjustment of the foot width b3 to the blade width b2 on the foot, the blade width b4 at the location of the deepest tooth cutout, and the blade width b1 at the tooth tip, an especially great free space between the foot shoulder 22 and the tooth tip 32c is ensured for an arrangement manufactured with a sawtooth wire illustrated in the drawing, wherein with the wire, while a good carding action is ensured, a high wear resistance can be achieved even when the sawtooth wire is produced of a comparatively inexpensive steel alloy of the aforementioned kind.

The invention is not limited to the embodiment explained width the aid of the drawing. Instead, the use of sawtooth wires with other dimensions is also conceivable. Moreover, in the context of this invention sawtooth wires with variable pitch p can also be used. Also, the use of sawtooth wires according to the invention with lockable foot sections is also conceivable.

While specific embodiments of the invention have been shown and described in detail to illustrate the inventive principles, it will be understood that the invention may be embodied otherwise without departing from such principles.

What is claimed is:

1. A sawtooth wire for manufacturing an all-steel sawtooth arrangement for the swift of a card, the sawtooth wire comprising:
a foot section having a foot shoulder;
a blade section adjoining the foot section at the foot shoulder;
the blade section comprising sawteeth formed by teeth cutouts extending from an edge of the blade section facing away from the foot section;
wherein a foot width of the foot section is approximately 0.2 to 0.6 mm; and
wherein a ratio of the foot width to a blade width of the blade section at a location of a deepest tooth cutout is greater than 2 and less than 3.5.

2. The sawtooth wire according to claim 1, wherein the ratio of the foot width of the foot section to the blade width of the blade section at the location of the deepest tooth cutout is greater than 2.5

3. The sawtooth wire according to claim 2, wherein the ratio of the foot width of the foot section to the blade width of the blade section at the location of the deepest tooth cutout is approximately 2.6.

4. The sawtooth wire according to claim 1, wherein the ratio of the foot width of the foot section to the blade width of the blade section at the location of the deepest tooth cutout is less than 3.

5. The sawtooth wire according to claim 1, wherein the blade width, beginning at the edge of the blade section facing away from the foot section, increases continuously in the direction toward the foot section at least over portions of the blade section, and wherein the ratio of the foot width to the blade width at a location where the blade section and the foot section meet is greater than 1.4.

6. The sawtooth wire according to claim 5, wherein the ratio of the foot width to the blade width at the location where the blade section and the foot section meet is approximately 1.6.

7. The sawtooth wire according to claim 1, wherein the foot width is approximately 0.4 mm.

8. The sawtooth wire according to claim 1, wherein a blade width at the edge of the blade section facing away from the foot section is approximately 0.02 to 0.2 mm.

9. The sawtooth wire according to claim 8, wherein the blade width at the edge of the blade section facing away from the foot section is approximately 0.05 mm.

10. The sawtooth wire according to claim 1, wherein the sawtooth wire is comprised of alloyed steel.

11. The sawtooth wire according to claim 10, wherein the alloyed steel comprises 0.3 to 2.0% by weight carbon, 0.1 to 2.5% by weight silicon, 0.1 to 2.0% by weight manganese, 0.1 to 2.0% by weight vanadium, and at least one of 0.1 to 2.0% by weight chromium and 0.6 to 0.7% by weight tungsten.

12. The sawtooth wire according to claim 10, wherein the alloyed steel comprises 0.80 to 0.85% by weight carbon, 0.40 to 0.60% by weight manganese, 0.10 to 0.30% by weight silicon, and at least one of 0.60 to 0.70% by weight tungsten and 0.15 to 0.20% by weight vanadium and less than 0.02% by weight phosphorus, with less than 0.02% by weight sulfur.

13. The sawtooth wire according to claim 1, wherein the blade section has lateral flanks with a roughness, wherein the roughness of the lateral flanks at least in the area of the teeth is less than 5 μm.

14. The sawtooth wire according to claim 13, wherein the roughness of the lateral flanks is less than 4 μm.

15. The sawtooth wire according to claim 1, wherein a pitch error, defined as a deviation of a nominal spacing between sawtooth tips of successively arranged sawteeth, is less than 2%.

16. The sawtooth wire according to claim 15, wherein the pitch error is less than 1%.
